(19) United States
(12) Patent Application Publication
(10) Pub. No.: US 2006/0209058 A1
(43) Pub. Date: Sep. 21, 2006

(54) Display

(76) Inventors: Tetsurou Nakamura, Takaraduka-shi (JP); Takanori Nakano, Neyagawa-shi (JP); Masaichirou Tatekawa, Minoo-shi (JP); Atsuhi Sogami, Sanda-shi (JP); Kouji Ikeda, Sanda-shi (JP); Kazuo Nishimura, Ibaraki-shi (JP); Masaki Kondou, Morigurichi-shi (JP); Ken-ichi Masumoto, Hirakata-shi (JP); Kouichi Takamine, Kawanishi-shi (JP)

Correspondence Address: GREENBLUM & BERNSTEIN, P.L.C., 1950 ROLAND CLARKE PLACE, RESTON, VA, 20191, US

(21) Appl. No.: 10/551,450

(22) PCT Filed: Mar. 31, 2004
(86) PCT No.: PCT/JP04/04724

§ 371 Date: Sep. 29, 2005

(30) Foreign Application Priority Data
Apr. 2, 2003 (JP) 2003-098902

(51) Int. Cl. G09G 5/00

(52) U.S. Cl. 345/211

(57) ABSTRACT

An electronic paper having a display unit formed of a flexible sheet. The electronic paper comprises the display unit composed of a light-emitting device and a switching device and a drive unit composed of a drive circuit disposed at one edge of the display unit. The light-emitting device and the switching device both operate at low operating frequencies and are made of a flexible organic semiconductor. Since the hardness of the drive unit can be high, a semiconductor device having a high operating frequency such as a C-MOS is provided to the drive unit. Though the switching time is relatively long, the data setting time can be short. As a result, a sharp image can be produced.

### TECHNICAL FIELD

This invention relates to a display that is an electronic paper as a flexible display medium.

### BACKGROUND ART

An electronic paper has comes out as a display like paper that is available for a communicative medium. Japanese Laid-open Publication No. 2001-312227 discloses an electronic paper as shown in FIG. 1 which is provide with a sheet display unit 200 for displaying an image, and a core unit 300 made up of a hard material to which the display unit is fixed with an adhesive. The core unit 300 is provided with a battery for supplying electric power to the display unit 200, arrow keys or decision keys for user to select an image to be displayed on the display unit 200.

The display unit 200 uses a flexible material like a plastic film to fold and roll the display unit like a sheet. The display unit 200 is provided with light-emitting devices in matrices, and adopts a passive matrix system or an active matrix system to control those light-emitting devices. In case of the passive matrix system, a displayed image is deteriorated because of an occurrence of a crosstalk among light-emitting devices. Accordingly, the recent light-emitting control tends to adopt the active matrix system.

### DISCLOSURE OF INVENTION

In order to control the light emitting in the active matrix system, it is required to mount an electronic paper 100 with switching devices for switching the on-off lighting of each light emitting device, drive circuits for control the switching devices, and so on.

When the electronic paper is mounted with the switching devices and the driving circuits, it is required to comply with at least 3 conditions such as following (1) to (3).

(1) A display unit has a flexibility for make the display unit user-friendly;

(2) an image displayed on the display unit should be sharp; and

(3) the displayed images can be switched smooth.

The present invention has an object to provide a display (an electronic paper) to comply with the above-mentioned conditions (1) to (3).

Before the definite means are explained, the circumstances of the invention are explained hereinafter.

In order to comply with the above conditions (1) to (3), the inventors found their ideas in a following process.

To meet the condition (2), it is preferable that (a) an operation of the drive circuit is stable, and (b) the switching device (the drive circuit, if possible) is disposed close to the light-emitting device as possible as it can, for the purpose of preventing the voltage drop and the noise.

Accordingly, as for the above (a), the drive circuit may adopt an inorganic semiconductor that has a stability as compared with an organic semiconductor.

In addition, as for the above (b), the switching device may adopt an organic semiconductor that does not require at the mounting a high temperature environment as compared with an inorganic semiconductor. This makes it possible to mount the light-emitting device and the switching device on the flexible sheet display unit (the condition (1)) that is not suited to the high temperature environment. In result, both devices can be disposed as close as possible.

It concludes that, to comply with the above condition (2), the organic semiconductor material is used to from the switching device, while the inorganic semiconductor material is used to form the drive circuit.

In order to comply with the above condition (3), as the drive circuit (which is a circuit for converting an image data inputted to the display unit to a data for controlling the switching device, in particular), an inorganic semiconductor that is superior to an operating speed (an operating frequency) is preferable to use. This is matching the above result of the condition (2).

The above consideration results in the invention with features that the switching device of the organic semiconductor is disposed on the flexible sheet display unit, while the drive circuit of the inorganic semiconductor is separately disposed on the core member with hardness more than the display unit.

Additionally, the active matrix system is applied to the light-emitting control of the light-emitting device mounted with the display unit, and the switching unit for the active matrix system is mounted with the display unit.

The drive circuit comprises a data setting unit, a data latch unit, and a necessary circuit for driving the switching device. The data setting unit is a circuit wherein an image data inputted to the display as a serial data is converted to a parallel data to be outputted to each switching unit controlling the light emitting of each light-emitting device formed in matrices, and then the converted data is set to a data for controlling each switching unit.

Under the above-mentioned configuration, the display unit mounted with the light emitting device and the switching unit are separated from the drive unit mounted with the data setting unit, so that optimum devices for respective the display unit and the drive unit can be selected and mounted according to a characteristic and number (the number of pixels) of light-emitting device, a device characteristic of the switching unit, a type of image to be displayed on the display unit such as a dynamic image, and a static image. Consequently, it is possible to realize the display unit wherein the image displayed on the display unit is sharp and the switching of the images is smooth.

The display comprises the display unit and the core member disposed on an edge of the display unit and mounted with the drive unit.

Under the above configuration, the switching unit adopts an organic semiconductor with a flexibility. The switching device of the organic semiconductor can be mounted with the sheet display unit even in the low temperature environment. This makes it possible to mount the switching device on the soft sheet such as a plastic film.

To display a sharp image, it is preferable that the drive circuit may be composed of a crystal type of CMOS-IC (Complementary Metal Oxide Semiconductor-integrated Circuit) that has a high performance, that is, a high operating frequency. The invention is configured so that the drive circuit of the crystal type CMOS-IC is mounted to an edge of a sheet of the display unit, the portion does not display images, and then the edge becomes the core unit, otherwise, the drive circuit of the crystal type CMOS-IC is mounted to a core member of a material different from the display unit, and then the core member is fixed as the core unit on an edge of a sheet of the display unit.

When the drive circuit is mounted to the edge of the sheet of the display unit, a portion that the display unit is mounted with the drive circuit gets hard and it makes the flexibility reduced. Therefore, to avoid the inconvenient facility caused from the reduced flexibility, it is preferable that the drive circuits may be collected and mounted on an edge of the sheet of the display unit together.

Likewise, where the core member is fixed on the edge of the sheet of the display unit, there is an effect that more flexible material can be applied to the display unit with ease.

Accordingly, while the active matrix system is applied to the light emitting control of the sheet using a flexible material like the plastic film, the crystal type CMOS-IC with the good operating stability and operating frequency can be used as the drive circuit. Therefore, it is possible to display a sharp image on the flexible sheet display unit.

Moreover, if the drive circuit is mounted to the core member, the drive circuit can be removed from the sheet as well as the number of components mounted on the sheet of the display unit can be reduced, whereby it is possible to provide a soft display unit.

In case of displaying the sharp dynamic image, it is preferable that the data setting time per light-emitting device of the data setting unit may be not more than 1% of the switching time per light-emitting device of the switching device.

In addition, where the display unit configured as above is provided with a control unit for supplying electric power to the data setting unit, if no data is inputted to the data setting unit for a specific time, the control unit may shut off the supply of electric power to the data setting unit. According to such control, the power consumption can be reduced, and in particular, in case of using the display unit by means of the battery, it is possible to extend the available time for use.

### BRIEF DESCRIPTION OF DRAWINGS

FIG. 1 is a schematic view of a display;

FIG. 2 is a view illustrating details of the display;

FIG. 3 is a view illustrating an inside of a core unit;

FIG. 4 is a cross-sectional view of the display along a line A-A′;

FIG. 5 is a cross-sectional view of the display along a line B-B′;

FIG. 6 is a cross-sectional view of the display along a line C-C′;

FIG. 7 is a diagram of the display with a display unit mounted with a drive circuit at an edge thereof;

FIG. 8 is a general view of the display and a main unit;

FIG. 9 is a schematic block diagram of the display;

FIG. 10 is a table showing a relation of the number of pixels, a display frame rate, and a data processing time of the display unit;

FIG. 11 is a conceptual diagram of an address period and a lighting period at displaying a dynamic image;

FIG. 12 is a schematic block diagram of a modified example of the display;

FIG. 13 is a detailed diagram illustrating the display unit of the modified example of the display; and

FIG. 14 is a flowchart showing a power supply control processing of the display.

### BEST MODE FOR CARRYING OUT THE INVENTION

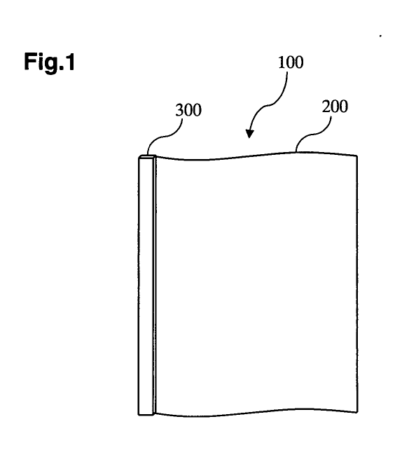

A display 100 of this invention, (which is an electronic paper 100 hereinafter), consists of a flexible sheet display unit 200 like a plastic film, and a core unit 300 made up of a harder material than the display unit 200, as shown in FIG. 1.

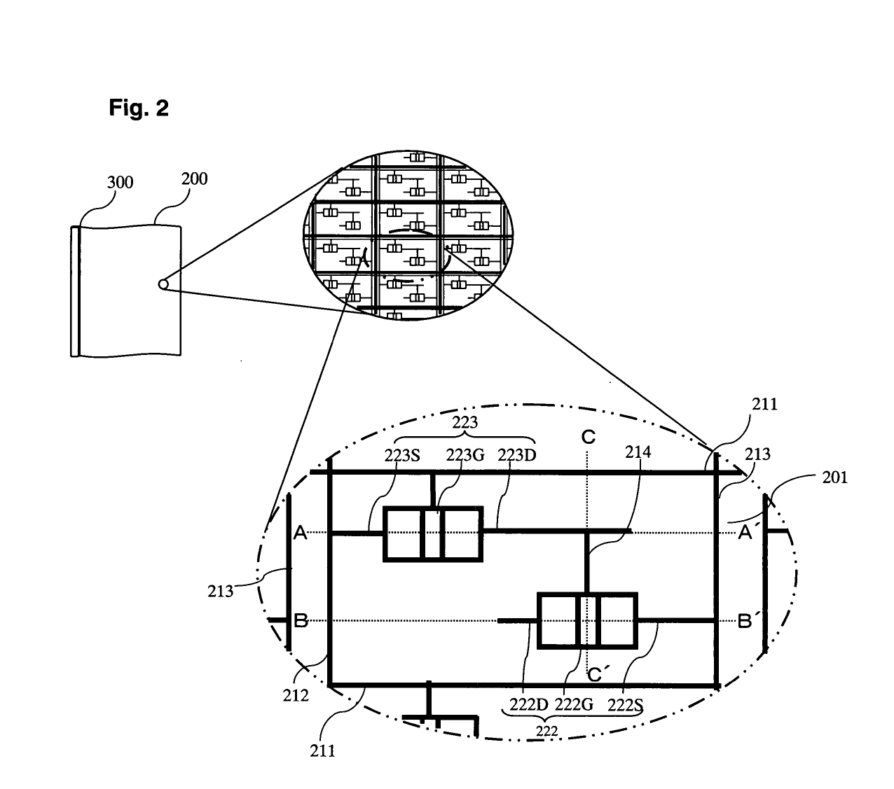

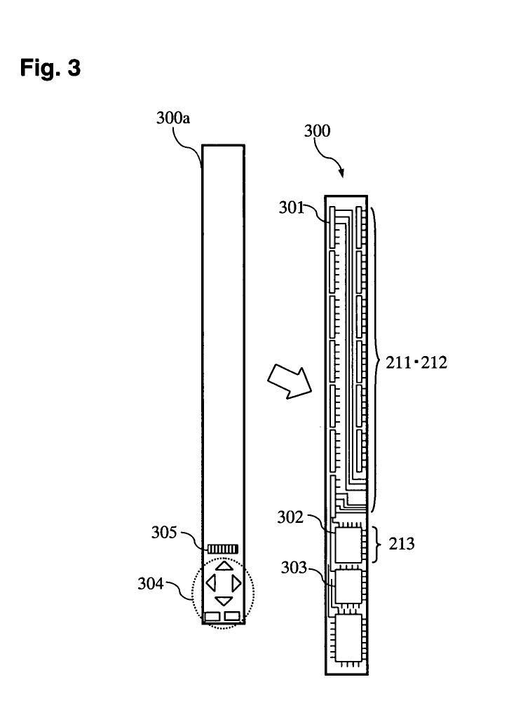

The display unit 200, on which light-emitting devices 201 are arrayed in matrices as shown in FIG. 2, can display images. The core unit 300 is formed by a core member 310 of which material is different from that of the display unit 200, and fixed at an edge of the display unit 200, as shown in FIG. 3. The core member 310 has a storage medium 303 storing image data to be displayed on the display unit 200, and a drive circuit 301 controlling the light emitting of the light-emitting devices 201 to display the stored image data in the storage medium 303 on the display unit 200 within, as shown in FIG. 3.

In the drive circuit 301, as more fully discussed later, an image data inputted to the electronic paper 100 is converted from a serial data to a parallel data, and then the converted data is set to a data to be outputted to each switching unit 220 controlling the light emitting of respective light-emitting devices. Specifically, the drive circuit 301 consists of a data setting unit 3011 formed by a shift register, and a data latch unit 3012 formed by a latch circuit that latches the parallel data temporarily and then outputs them to the switching unit 220.

This embodiment discusses a case when the drive circuit 301 is formed by a crystal type of CMOS-IC, however, the type of transistor forming the drive circuit 301 is not limited to the crystal type of CMOS-IC.

An operation key 304 is provided to a surface 310a of the core member 310, and by means of the operation key 304 a user inputs a display command for displaying an image on the display unit 200, a termination command for terminating the displaying, and a selection from display modes discussed later. When the display command is inputted from the operation key by the user, the drive circuit 301 sends a necessary signal for an on-off switching of each light-emitting device 201 in order to display an image data stored in the storage medium 303. Data lines 211 and gate lines 212 are inducted from the drive circuits 301 to a portion on which the display unit 200 is fixed, so as to send the signal to the switching unit 220 mounted on the display unit 200 for switching the light emitting device 201.

The core member 310 is provided with a power supply means for activating the drive circuit 301 and supplying electric power to the light-emitting device 201, like a battery 302. A power supply line 213 for supplying electric power from the battery 302 to the light-emitting device 201 is inducted from the battery 302 to the portion on which the display unit 200 is fixed. On the surface of the core member 300, a connector 305 is provided for supplying charging electric power to the battery 302 from an external.

The charge of the battery 302 is performed by connecting the connector 305 with a plug socket by an electric wire. A charge system is not limited to this, but it may be performed by inserting the core unit 300 into a stand type battery charger, and then plugging a plug of the battery charger in a plug socket. As a method of charging the battery 302, a sheet battery is available, or a solar battery using solar light is also available.

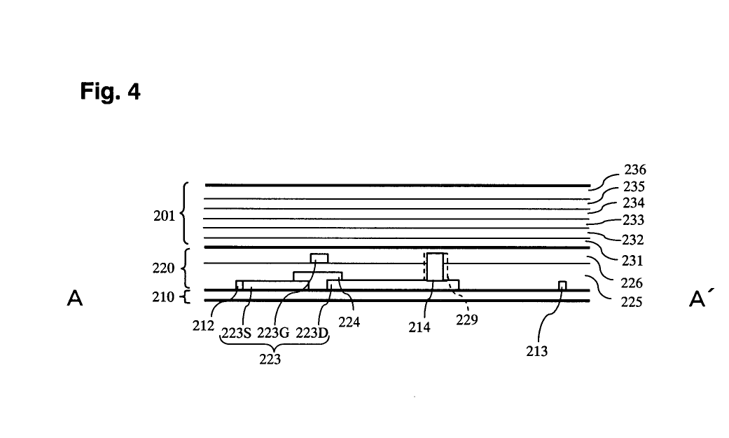

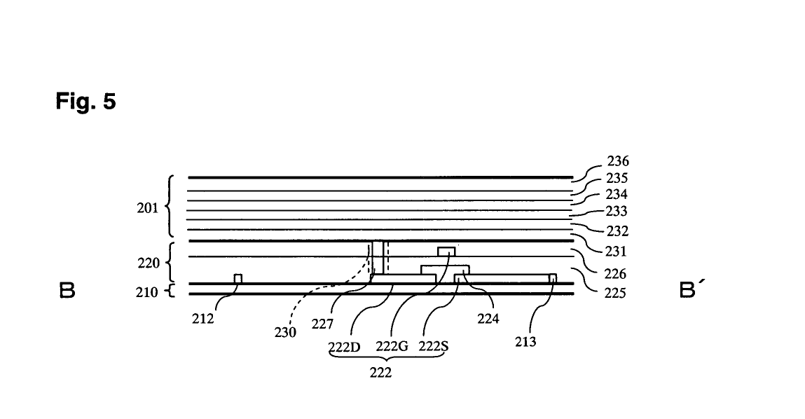

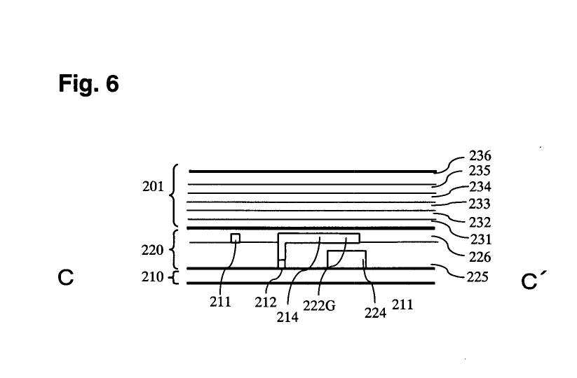

The lowest layer of the display unit 200 is formed by a transparent sheet 210 that is made up of a flexible transparent material, like a plastic film, as shown in FIG. 4 that is a cross-sectional view of FIG. 2 along a line A-A′; FIG. 5 that is a cross-sectional view of FIG. 2 along a line B-B′; and FIG. 6 that is a cross-sectional view of FIG. 2 along a line C-C′. On the transparent sheet 210, the switching units 220 for controlling the on-off switching of the light-emitting device 201 are formed in matrices, and then the light-emitting devices 201 are formed thereon.

The switching unit 220 in the embodiment consists of a driving TFT (Thin Film Transistor) 222 for the on-off switching to supply electric power to the light-emitting device 201, and a switching TFT 223 for controlling the driving TFT so as to supply electric power only to the light-emitting device 201 designated by the drive circuit 301.

A plurality of the switching units 220 are formed on the transparent sheet 210 together, in a following manner.

As shown in FIGS. 2 to 4 and FIG. 6, on the transparent sheet 210, the data line 212 for transferring a data signal from the drive circuit 301 of the core unit 300 to each switching TFT 223, and the power supply line 213 for supplying electric power to each driving TFT 222 are formed by the printing.

Sequentially, a source 222S of the driving TFT 222 is formed so as to be connected to the power supply line 213, and a source 223S of the switching TFT 223 is formed so as to be connected to the data line 212. Drains 222D and 223D are formed at positions opposite to respective sources 222S and 223S of the driving TFT 222 and the switching TFT 223.

Between the source and the drain of the driving TFT 222 and the switching TFT 223, an organic semiconductor 224 is applied on. After the organic semiconductor 224 is applied on each switching unit 220, a gate insulator 225 is applied on the whole surface of the transparent sheet 210.

After applying the gate insulator 225, it forms a switching signal line 214 connecting the drain 222D and a gate 222G so that a data signal flowing to the drain 223D of the switching TFT 223 may be inputted to the gate 222G of the driving TFT 222 as a gate signal of the driving TFT 222.

In order to form the switching signal line 214, a through-hole 229 is bored through a top surface of the gate insulator 225, whereby a part of the drain 223D of the switching TFT 223 is exposed. Sequentially, the switching signal line 214 is formed from the drain 223D to the top surface of the gate insulator 225 corresponding to a position right over the part between the gate and the drain of the driving TFT 222, through the through-hole 229.

An end of the switching signal line 214 on a side of the driving TFT is positioned over the part between the source and the drain of the driving TFT 222, so that the end works as the gate 222G of the driving TFT 222.

After forming the switching signal line 214, the gate line 211 is formed on the gate insulator 225 in order to transmit the gate signal from the drive circuit to the switching TFT 223 through the gate line 211 formed on the core unit 300. A gate 223G of each switching TFT 223 is formed so as to be connected to the gate line 211.

After forming the gate line 211, the whole top surface of the gate insulator 225 is coated with an insulator 226.

Since the top surface of the insulator 226 is provided with the light-emitting device 201 in an under-mentioned way, the current flow from the source 222S of the driving TFT 222 to the drain 222D should be carried to the top surface to the insulator 226. Therefore, a through-hole 230 is bored through the top surface of the insulator 226, whereby the drain 222D is exposed. The through-hole 230 is mounted with an interconnection 227 that connects the drain 222D with the light-emitting device 201.

After forming the interconnection 227, the switching unit 220 is completed.

Upon the completion of the switching unit 220, the light-emitting device 201 is formed on the top surface of each switching unit 220 as follows.

Besides, this embodiment discusses only a case using an organic EL as the light-emitting device.

An anode 231 is formed by applying ITO (Indium-Tin-Oxide) on the top surface of each switching unit 220, and ITO becomes the anode 231. Where the drive circuit 301 is configured to control the isolated on-off switching of the light emitting of each light-emitting device 201, ITO corresponding to each pixel may be applied on the top surface of each switching unit 220 so as not to contact each other.

Next, a hole transporting layer 232 is formed by applying a hole transporting material on the top surface of the anode 231 on the top surfaces of plural switching units 220. A light emitting material 233 is applied on the top surface of the hole transporting layer 232, whereby a light emitting layer 233 is formed.

After forming the light emitting layer 233, an electron transporting layer 234 is formed by applying an electron transporting material on the top surface of the light emitting layer 233, and then a material to form a cathode 235 common to each light-emitting device 201 is applied on the whole top surface of the electron transporting layer 234. In addition, in order to connect the cathode 235 with the power supply line 213 of the core member 310 when the display unit 200 is fixed on the core member 310, it is mounted with the power supply line for the cathode, which is not shown in the drawing. Under such configuration, when a voltage is applied on the anode 231 and the cathode 235, the light emitting layer 233 between the anode 231 and the cathode 235 emits the light.

To protect the light emitting layer 233, the insulator 236 is applied on the cathode 235. After applying the insulator 236, the light emitting device 201 is formed on the top surface of each switching unit 220, and then the display unit 200 is completed.

The display unit 200 is fixed on the core member 310 with a conductive adhesive so as to connect electrically the gate line 211, the data line 212, and the power supply line 213 that are formed on the display unit 200 and the core member 310 as shown in FIG. 3. Consequently, the electronic paper 100 is completed.

The above discussion refers to a case where the drive circuit 301 is mounted to the core member 310 that is a different unit from the display unit 200. It is based on the consideration that, when the drive circuit 301 is mounted to the core member 310 instead of the display unit 200, the flexibility of the display unit can be maintain in good condition rather than the drive circuit direct mounted to the display unit.

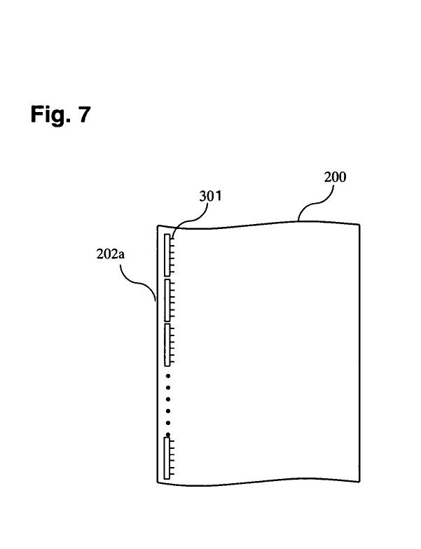

Accordingly, unless the flexibility of the display unit 200 lowers extremely, the drive circuit 301 may be mounted to the display unit 200. For instance, the drive circuit 301 may be mounted to another edge 200a of the display unit 200 that does not display the image, and the edge 200a may become the core unit 300, as shown in FIG. 7.

In case of mounting the drive circuit 301 to the edge 200a of the display unit 200, the hardness of the edge 200a increases. Even when the core member 310 is fixed on the display unit 200, the hardness of the edge 200a fixed with the core member 310 also increases. Accordingly, even though the core unit 300 is formed on the edge 200a of the display unit 200, the manipulation does not get worth.

In case of forming the edge of the display unit 200 as the core unit 300, the gate line 211, the data line 212, and the power supply line 213 are inducted into the edge of the display unit 200, to which the drive circuit 301 like the crystal type of CMOS-IC is mounted by means of the flip-chip technology, so as to be mounted directly by the face-down mounting. In result, the edge of the display unit 200 becomes the core unit 300.

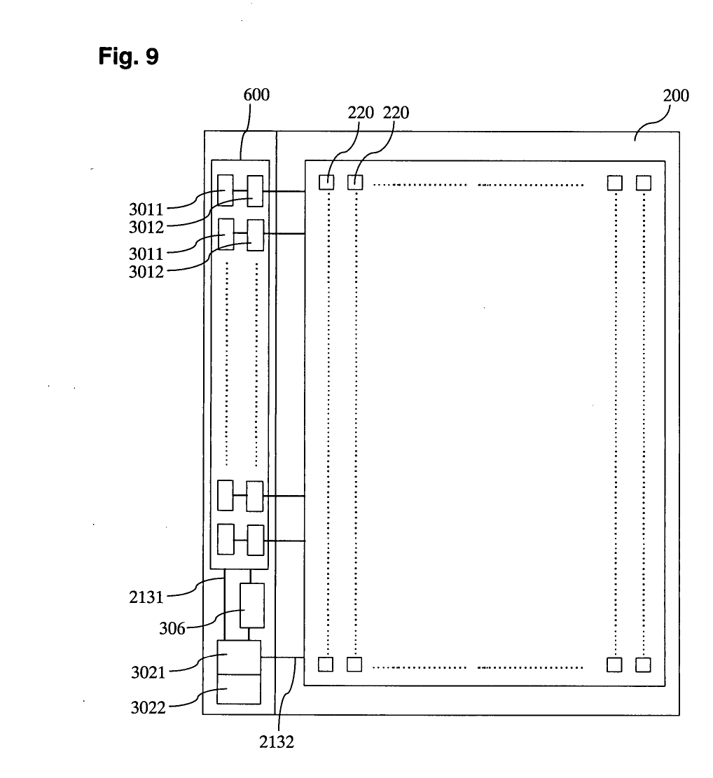

In view of the display performance of dynamic image, the features, which are required to the switching unit 220 and the data setting unit 3011 of the drive circuit 301, are discussed hereinafter according to FIGS. 9 to 11.

FIG. 9 is a schematic block diagram of the electronic paper shown in FIGS. 1 to 6. In FIG. 9, the power supply line 213 shown in FIG. 3 is separated to a data setting unit power line 2131 for supplying electric power to the data setting unit 3011 and a switching unit power line 2312 for supplying electric power to the switching unit, while the battery 302 is separated to a control unit 3021 and a power supply 3022 for controlling respective electric power to be supplied to the data setting unit 3011 and the switching unit 220. The drive circuit 301 is separated to the data setting unit 3011 for setting the data controlling the switching unit 220 and a data latch unit 3012 for latching temporarily the data set by the data setting unit 3011.

To ensure the flexibility of the display unit 200, the switching unit 220 is preferable to be mounted with the organic TFT, as described before. Moreover, the data setting unit 3011 is preferable to be mounted on the display unit 200 if possible, in order to prevent the voltage drop or the noise generation caused from an interconnection connected to the switching unit 220.

The data setting unit 3011, however, receives the image data that is a serial data, and then convert it to a parallel data, as described before. Therefore, the data setting time in the data setting unit 3011 becomes longer as increased the data amount converted from the serial data to the parallel data, that is, as increased the frequency of the data processing (the data shifting) by the shift register.

When the data setting unit 3011 is formed by a device having the same characteristic as the switching unit 220 formed by the organic TFT, the data setting time in the data setting unit 3011 becomes longer extremely than the switching time of the switching unit 220, and the rate for switching the images is restricted by the data setting time in the data setting unit 3011.

To avoid the restriction on the image switching rate, the invention is configured so that the data setting unit 3011 has a different characteristic from that of the switching unit 220, and the data setting unit 3011 and the switching unit 220 are separated and mounted to the display unit 200 and a drive unit 600 respectively. The characteristics of the device are an operation frequency and a dynamical flexibility of the material forming the device.

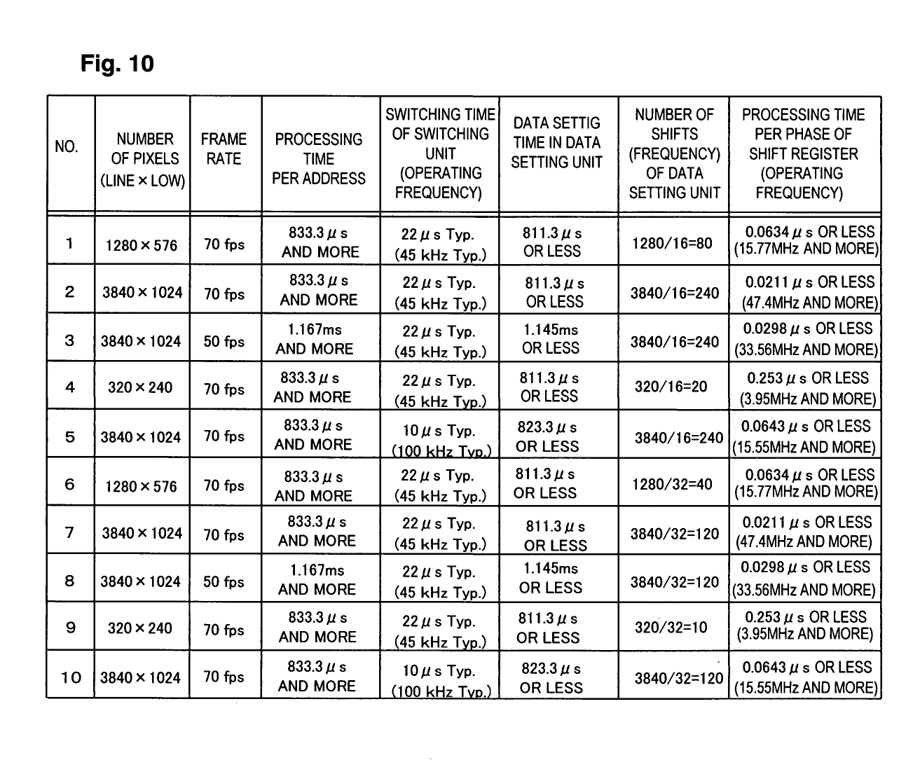

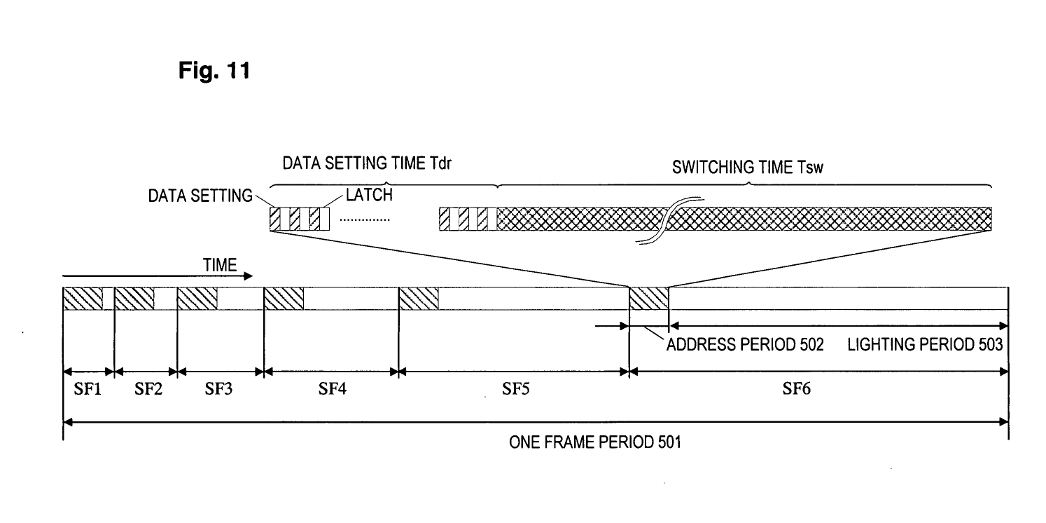

According to FIG. 10 and FIG. 11, here is discussed about thus formed electronic paper regarding the relation of the number of pixels, a frame rate, the number of shifts of the data setting unit 3011, the switching time per light-emitting device of the switching unit 220, and a total processing time per scanning line.

FIG. 11 is a conceptual diagram showing an address period 502 within one frame period 501, and a lighting period 503 of the light-emitting device 201, at the 64 halftone display. The address period 502 is a time for the processing time of the data setting unit 3011 and the data latch unit 3012, and the switching of the switching unit 220.

As shown in FIG. 11, one frame period 501 consists of 6 sub-frames (the sub-frame is abbreviated to SF hereinafter). Those 6 sub-frames have respective lighting periods 503, of which time proportion can be expressed such that, where SF1 is 1, SF2 is 2, SF3 is 4, SF4 is 8, SF5 is 16, and SF6 is 32. The 64 halftone display can be carried out by controlling the lighting period 503 of 6 bits from SF1 to SF6.

Each sub-frame is composed of the address period 502 and the lighting period 503. Where the number of display pixels is m×n(m>n), after repeating within the address period 502 of one sub-frame the data setting (the data conversion operation from a serial data to a parallel data) and the latching (the data latching operation by the data latch unit) for N times (N=m/L), N is a quotient when m is divided by a shift register length L, the switching unit 220 is controlled based on the latched data.

Where the number of pixels is 1280×576 and a horizontal scanning frequency is 90 kHz, a maximum vertical scanning frequency is 90 kHz/576=153.25 Hz. Since the dynamic image cannot be displayed at higher frame rate than the maximum vertical scanning frequency, the frame rate is defined as 70 fps (one frame period: 14.28 ms). When the lighting period 503 is equivalent to 65% of one frame period 501, the lighting period 503 is 14.28 ms×65%=9.28 ms.

On the contrary, the data setting in the data setting unit 3011 and the switching of the switching unit 220 should be completed within a remaining time after the lighting period is subtracted from one frame period 301. Accordingly, the time for the processing of the data setting unit 3011 and the switching unit 220 has to be fully shorter than 14.28 ms−9.28 ms=5 ms. In this embodiment, the processing time for the latching is disregarded because of an after-mentioned reason.

In order to output a high minute image, since one frame has 6 sub-frames in view of the 64 halftone display, the processing time of the address period for one sub-frame should be not more than 5 ms/6=833.3 μs.

As described before, the address period 502 consists of the data setting and the switching. If the switching time of the switching unit 220 formed by the organic TFT is 22 μs (operating frequency 45 kHz), the maximum of the data setting time is 833.3 μs−22 μs=811.3 μs.

Where the shift register length is 16 bits, the number of data per horizontal scanning line is 1280 bits that is the number of pixels. Accordingly, the frequency of the shifting per line is 1280/16=80. In result, the data shift time per shift must be completed within 811.3 μs/80=10.14 μs. Since the sift register length is 16 bits, the setting time per setting in a shift register (the processing per light-emitting device) must be completed within 10.14 μs/16 bits≅0.634 μs.

It results in that the operating frequency of the device forming the data setting unit 3011 must be 1.578 MHz and more (FIG. 10, No. 1). When the image is displayed in fact, however, it is configured so that an enough spare time is given to the data setting time in the data setting unit 3011, and the devices bear one digit higher operating frequency. This makes it possible to disregard the characteristic dispersion of respective devices forming the data setting unit 3011 and the switching unit 220. Therefore, the device in this case should be a one having the characteristic that the setting time is not more than 0.0634 μs, that is; the operating frequency is 15.78 MHz and more.

As the device of the data setting unit 3011 of which the operating frequency is 15.78 MHz and more, there is the above-mentioned crystal type CMOS (the operating frequency: 20 MHz), for example.

In the above explanation, the processing time for the latching processed by the data latch unit 3012 was disregarded, but the processing time can be completed within the spare time provided to the data setting time, because the latching time is an operating time for receiving and latching the data outputted from the data setting unit 3011.

FIG. 10 shows examples that the number of pixels on the display unit is different, and also shows the results of the operating frequency calculated in the same way as above.

Regarding a case No. 2 shown in FIG. 10, for example, the frame rate is the same as that of No. 1, but the number of pixels (3840×1024) is more than that. Accordingly, a device of the data setting unit 3011 should have a high operating frequency, such as 47.48 MHz. Regarding a case No. 3 in FIG. 10, since the frame rate reduces to 50 fps, the operating frequency for the data setting unit 3011 becomes 33.56 MHz. In case of using the device having the operating frequency lower than that of case No. 2, the case No. 2 with the same number of pixels as case No. 3, it is possible to perform the excellent displaying.

On the other hand, in a case No. 4, the frame rate is 70 fps but the number of pixels (320×240) gets reduced. In this case, the operating frequency of the data setting unit 3011 may be 3.95 MHz and more, and even in such low operating frequency, it is possible to perform the excellent displaying.

Even in case corresponding to the number of pixels of HD (High Definition) image such as cases No. 2 and No. 7 in FIG. 10, if the operating frequency of the switching unit 220 can be improved to 100 kHz, for example, a device having the 15.55 MHz and more operating frequency can be selected as the data setting unit 220 as shown in No. 5 and No. 10 in FIG. 10. Then, it is possible to perform the excellent displaying.

In view of the above-mentioned description, it is obvious that the device characteristic of the data setting unit 3011 displaying excellent dynamic images changes depending on the number of pixels and the frame rate. In any case of No. 1 through No. 4 in FIG. 10, where the data setting time per light-emitting device of the data setting unit 3011 is Tdr, and the switching time per light-emitting device of the switching unit 220 is Tsw, it is understood that the data setting time Tdr is preferable to an extremely smaller value than the switching time Tsw (Tdr<<Tsw).

Even if the shift register length is 32 bits, like the cases No. 6 to No. 9 in FIG. 10, the data setting time Tdr remains unchanged. Therefore, like the cases No. 1 to No. 4 in FIG. 10, the data setting time Tdr is preferable to extremely smaller than the switching time Tsw.

When calculating the relation between the data setting time Tdr and the switching time Tsw regarding the case No. 4 in FIG. 10, wherein the data setting time Tdr is a maximum value, the data setting time Tdr/the switching time Tsw=0.253 μs/22 μs=0.0115. Accordingly, in view of the display performance of the dynamic image, the data setting time Tdr is preferable to a value not more than 1% of the switching time Tsw.

As mentioned above, it is configured so that the display be separated to the drive unit 600 mounted with the drive circuit 301 including the data setting unit 3301 and the display unit mounted with the switching unit 220. This makes it possible to select the device of the data setting unit 3011 so that the data setting time per light-emitting device of the data setting unit 3011 gets extremely shorter than the switching time of the switching unit 220, and then it is possible to realize the image output at an appropriate image switching rate.

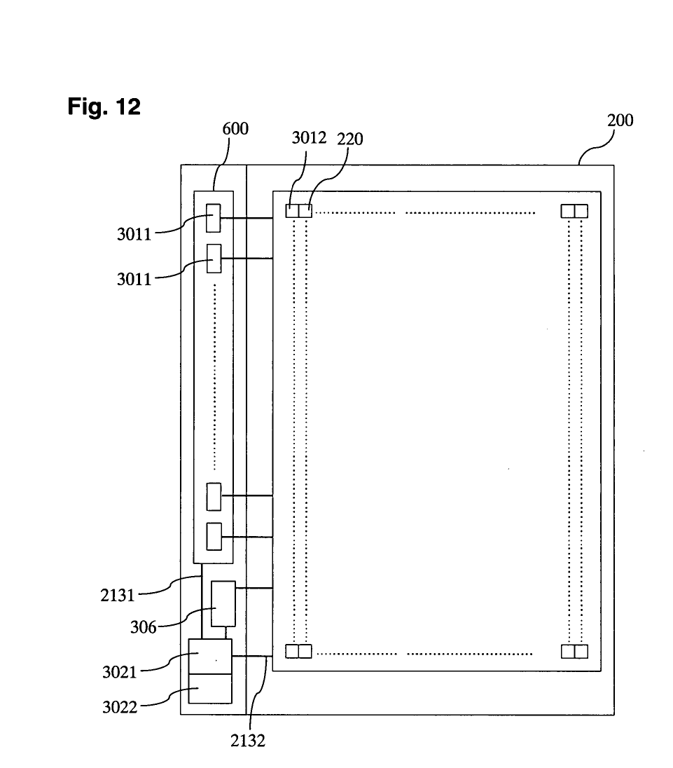

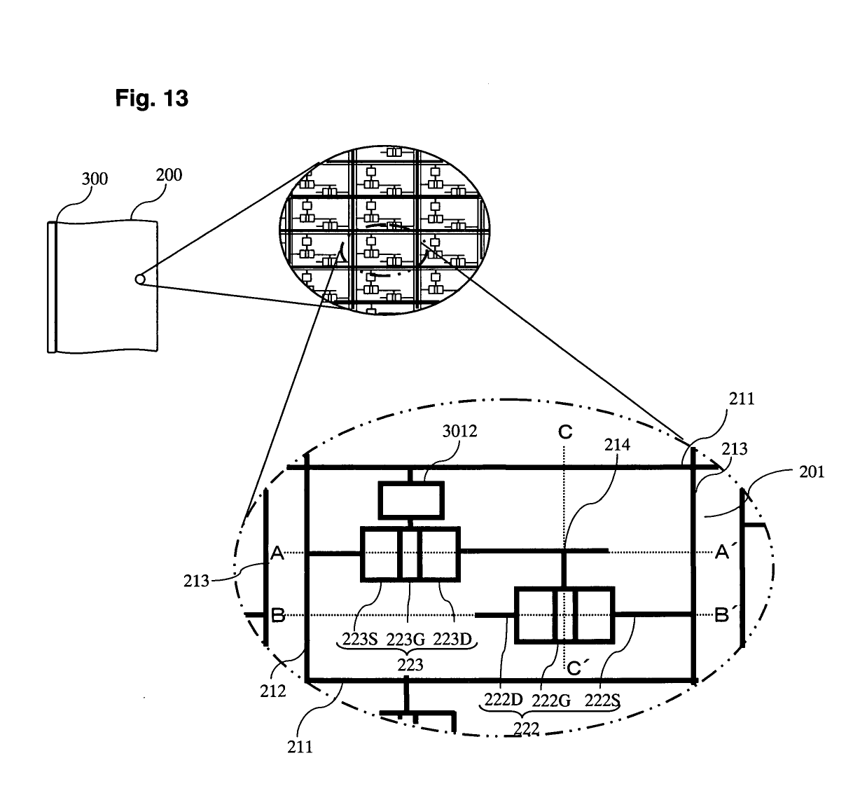

Additionally, the above embodiment refers to a configuration that the data latch unit 3012 is mounted to the drive unit 600 including the data setting unit 3011. The data latch unit 3012, however, may be interconnected to a gate 223G of the switching TFT 223 forming the switching unit 220, and be mounted to the display unit 200, as shown in FIG. 12 and FIG. 13. Besides, in FIG. 12, the other parts except for the data latch unit 3012 are the same as the components in FIG. 9. In FIG. 13, the other parts except for the data latch unit 3012 are the same as the components in FIG. 4.

Regarding the electronic paper 100 shown in FIG. 1 to FIG. 6, the operation is discussed hereinafter.

When a user press down a power supply key that is one of the operation key 304 provided on the core unit 300 of the electronic paper 100, the electric power is supplied from the power battery 302 to the source 222S and the cathode 235 of each driving TFT 222 through the driving circuit 301 and the power supply line 213.

When the electric power is supplied, the driving circuit 301 obtains the image data stored in the storage medium 302, and then sends the gate signal and the data signal based on the image data through the gate line 211 and the data line 212.

The switching TFT 223, when the data signal is inputted to the source 223S while the gate signal is inputted to the gate 223G, sends the data signal from the gate 223G to the drain 223D. The data signal sent to the drain 223D is inputted to the gate 222G of the driving TFT 222 through the switching signal line 214.

After the data signal is inputted to the gate 222G, the electric power supplied to the source 222S flows to the drain 222D, and then flows to the anode 231 through the interconnection 227.

In result, the electric power is supplied to the anode 231 of the light-emitting device 201, and the light-emitting device 201 emits the light. In such way, the on-off control is made on the light emitting of the light-emitting device 201.

The light emitted from the light emitting device 201 goes out to an outside of the display unit 200 through the switching unit 220 and the transparent sheet 210, as shown in FIG. 4 to FIG. 6.

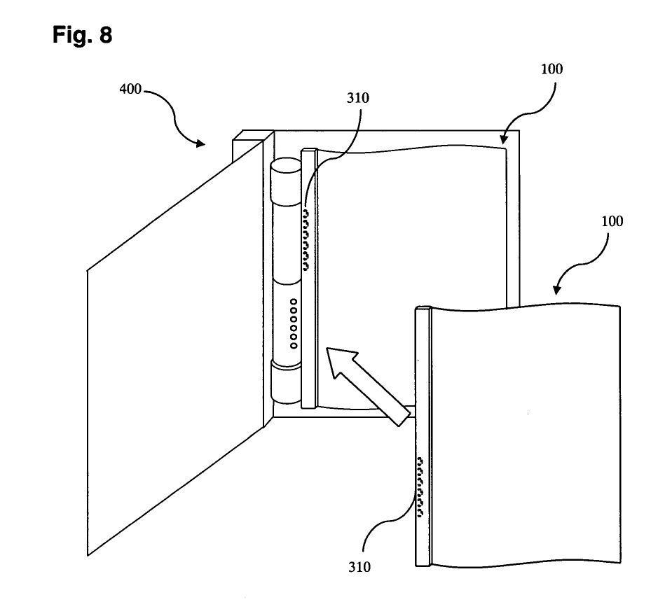

The core unit 300 of the electronic paper 100 is provided with a terminal 320 by which the electronic paper can be attached or removed physically and electrically to and from a main unit 400 capable of mounting plural electronic papers, as shown in FIG. 8. In such way, the electronic paper may be used like a sheet of a loose-leaf. Since the main unit 400 and the electronic paper 100 are interconnected electrically in this configuration, the battery 302, the storage medium 303, and an operation unit 304 may be mounted to the main unit 400.

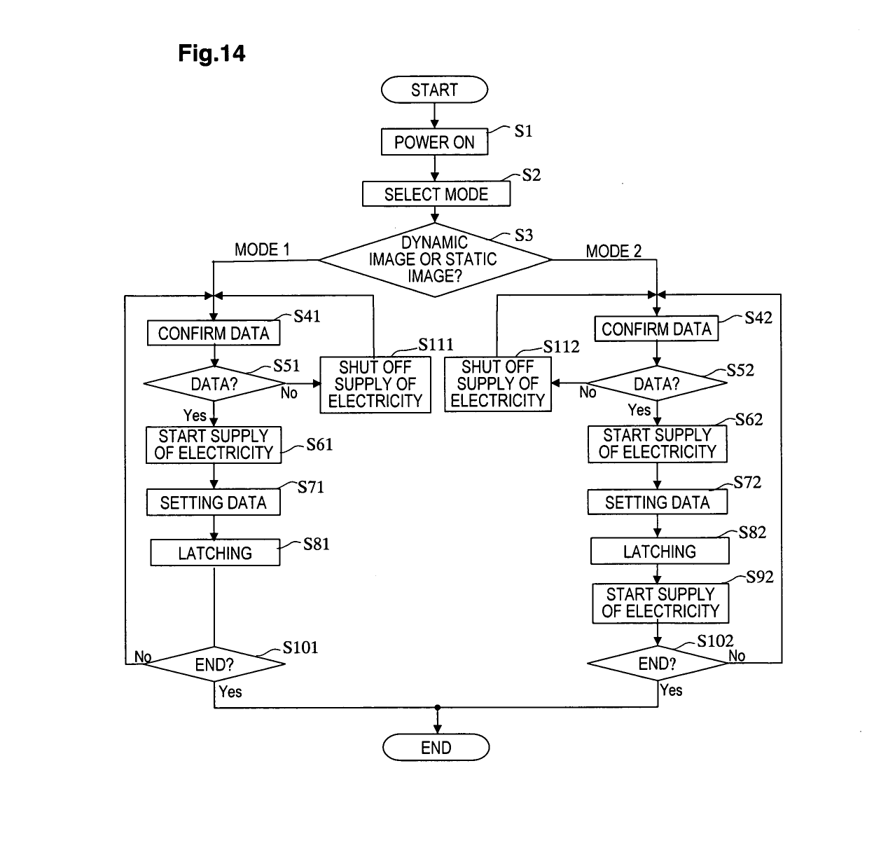

The processing that the electronic paper 100 displays the image data on the display unit 200 is discussed here according to FIG. 14. The electronic paper 100 in the under-mentioned explanation is provided with two display modes; a dynamic image mode for displaying an image data as a dynamic image, and a static image mode for displaying an image data as a static image.

At starting the displaying of the electronic paper 100, the user operates the operation key 304 shown in FIG. 3 to turns on the main power of the electronic paper 100 (FIG. 14, S1). This operation supplies electric power to all the circuits for displaying the image data, such as, the data setting unit 3011, the data latch unit 3012, the switching unit 220, and the light-emitting device 201, as shown in FIG. 9.

Next, the user selects an operation mode of the electronic paper 100, the dynamic image mode or the static image mode, by means of the operation key 304 (FIG. 14, S2).

When the user selects the dynamic image mode (FIG. 14, S3, Mode 1), the control unit 3021 confirms a serial data inputted to the data setting unit 3011 (FIG. 14, S41). The confirmation of the serial data can be made easily, for example, the control unit 3021 may monitor the serial data inputted to the data setting unit 3011.

When there is no serial data at the confirmation (FIG. 14, S51, No), the control unit 3021 breaks a switch disposed on a path for supplying electric power from the battery 302 to the data setting unit 3011, and shuts off the supply of electric power to the data setting unit 3011 (FIG. 14, S11). The judgment that there is no serial data is configured so that the control unit 3021 monitors the serial data inputted to the data setting unit 3011 for a specific time, and if the control unit 3021 cannot detect the serial data within the specific time, it may decide that there is no serial data.

After the control unit 3021 shuts off the supply of electric power to the data setting unit 3011, the control unit 3021 confirms the serial data and judges whether or not there is a serial data (FIG. 14, S41 to S51) again. Accordingly, when it is judged again that there is no serial data inputted, the break of supplying electric power to the data setting unit 3011 is continued.

On the other hand, when it is judged that there is a serial data (FIG. 14, S51, Yes), the control unit 3021 supplies electric power to the data setting unit 3011. That is to say, in case of supplying electric power to the data setting unit 3011, the control unit continues to the supply, otherwise, in case of breaking the supply of electric power to the data setting unit 3011, the control unit starts to supply electric power (FIG. 14, S61).

At this time, the data setting unit 3011 receives the serial data and executes the conversion from the serial data to a parallel data (data setting) (FIG. 14, S71), and then outputs the parallel data to the latch circuit that is the data latch unit 3012 (FIG. 14, S81).

Upon receipt of the parallel data, the data latch unit 3012 latches the data till a new data is inputted from the data setting unit 3011. According to the data latched by the data latch unit 3012, the switching unit 220 controls the light emitting of the light-emitting device 201 by controlling the current flowing into the light-emitting device 201.

After the data setting unit 3011 completes the output of the parallel data to the data latch unit 3012, the control unit 3021 judges whether or not the user selects a termination of displaying the image data by means of the operation key 304, that is, judges whether or not there is a termination instruction of displaying the image data (FIG. 14, S101). If there is no termination instruction, it turns back to a step of confirming the serial data, and executes the subsequent steps (FIG. 14, S101, No).

When the user selects the termination of displaying the image data and the control unit judges there is the termination instruction of displaying the image data, the processing of displaying the image data is terminated (FIG. 14, S101, Yes).

The invention is configured so as to shut off the supply of electric power to the data setting unit 3011 under a condition that there is no inputted serial data, with the result that the power consumption of the electronic paper can be reduced. In particular, when the electronic paper is operated by the battery under a mobile environment, the available operation time of the electronic paper can be extended.

The operation, in case where the user selects the static image mode, is discussed hereinafter.

When the control unit 3021 judges the selected mode and that the static image mode is selected (FIG. 14, S3, mode 2), it confirms whether or not there is a serial data, in the same way as the dynamic mode (FIG. 14, S42).

At this time, the processing when the control unit 3021 judges there is no serial data (FIG. 14, S52, No to S112 to S42), and the processing that, when the control unit 3021 judges there is a serial data, the data setting unit 3011 outputs the parallel data to the data latch unit 3012 (FIG. 14, S52, Yes to S82); those processing are the same as in the dynamic image mode, and those is not discussed here.

In the static image mode, when the data setting unit 3011 completes the output of the parallel data to the data latch unit 3012, the control unit 3021 shuts off the supply of electric power to the data setting unite 3011 (FIG. 14, S92), which is different from the dynamic image mode.

The control unit 3021 judges whether or not there is the termination instruction of displaying the image data, and if there is no termination instruction, it turns back to the step of confirming the serial data and the subsequent processing are executed (FIG. 14, S102, No). If there is the termination instruction, the processing is terminated (FIG. 14, S102, Yes).

As described above, when the static image mode is selected, the invention is configured so as to shut off the supply of electric power to the data setting unit 3011 after the data setting unit 3011 completes the output of parallel data to the data latch unit 3012. Therefore, there are effects that the power consumption can be reduced and the available operation time of the electronic paper can be extended, like the dynamic image mode.

In addition, the electronic paper may be configured as shown in FIG. 9 so as to be provided with a storage unit 306 like a flash memory wherein a data is rewritable thereon electrically and can be latched in a state without power supply. The storage unit 306 may store an image data displayed lastly, that is, the data that the data latch unit 3012 latches when it is judged that there is the termination instruction of displaying the data.

According to the above-mentioned configuration, even if the main power is turned off when the user browses an image data under the mobile environment, the data stored in the storage unit 306 may be set to the data latch unit 3012 when the main power is turned on again. Therefore, the user can start to browse the image data from the power-off state, and the facility can be improved.

If it is possible to select whether or not the image data displayed lastly is stored in the storage unit 306, the display unit can display nothing selectively when the user turns the power on.

### INDUSTRIAL APPLICABILITY

The invention has an effect that a sheet display unit can display a sharp image, and a flexible sheet display unit can be provided, which is useful as a display of an electronic paper, and the like.

1. A display comprising:
a plurality of light-emitting devices;
switching units operable to switch on and off of the respective light-emitting devices;
a drive circuit operable to drive the switching units;
a display unit mounted with the light-emitting devices and the switching units; and
a drive unit disposed on an edge of the display unit mounted with the drive circuits.

2. A display according to claim 1, wherein the display unit is a sheet, the drive unit is formed on a core unit on an edge of the display unit and having a hardness larger than the display unit.

3. A display according to claim 2, wherein the drive unit is formed on the edge of the display unit, and the edge cures and becomes the core unit by forming the drive unit.

4. A display according to claim 2, wherein a core member mounted in advance with the drive unit is fixed on the edge of the display unit as the core unit.

5. A display according to claim 2, wherein the drive unit is formed in a state that the core member is fixed on the edge of the display unit as the core unit.

6. A display according to claim 2, wherein an organic TFT (Thin Film Transistor) is used to the switching unit.

7. A display according to claim 2, wherein a crystal type of CMOS-IC (Complementary Metal Oxide Semiconductor-integrated Circuit) is used to the drive circuit.

8. A display according to claim 2, wherein the core unit is provided with power supply means for supplying electric power to the light-emitting devices.

9. A display according to claim 8, wherein the power supply means is formed by a battery.

10. A display according to claim 9, wherein the battery as the power supply means is charged from a solar battery or a sheet battery.

11. A display according to claim 8, wherein the core unit is provided with a connector for supplying electric power from outside to the power supply means.

12. A display according to claim 1, wherein the drive circuit is provided with a data setting unit for setting a data for controlling the switching device.

13. A display according to claim 12, wherein a device characteristic of the switching unit is different from a device characteristic of the data setting unit.

14. A display according to claim 13, wherein the device characteristics are operating frequencies.

15. A display according to claim 13, wherein the device characteristics are an operating frequency, and a mechanical flexibility of a material forming the device.

16. A display according to claim 13, wherein the data setting time per light-emitting device of the data setting unit is not more than 1 percent of the switching time per light-emitting device of the switching unit.

17. A display according to claim 12, further comprising:
a control unit operable to control the supply of electric power to the data setting unit,
wherein, in case of inputting no data to the display for a specific time, the control unit shuts off the supply of electric power to the data setting unit.

18. A display according to claim 12, further comprising:
a control unit operable to control the supply of electric power to the data setting unit, responsive to at least two modes of a dynamic image mode for displaying a data inputted to the display on the display unit as a dynamic image, and a static image mode for displaying the data as a static image; and
a data latch unit operable to latch a data outputted from the data setting unit and output the latched data to the switching unit,
wherein, in the static image mode, after the data latch unit latches the data outputted from the data setting unit, by the time when the data is inputted to the display unit, the data control unit shuts off the supply of electric power to the data setting unit.

19. A display according to claim 18, further comprising:
a storage unit for storing the data latched by the data latch unit,
wherein, when the electric power to be supplied to the display unit is shut off all and then supplied again, the control unit supplies the electric power to each unit in a state same as before the supply of power is shut off, as well as set the data stored in the storage unit to the data latch unit.
